(19) United States
(12) Patent Application Publication
(10) Pub. No.: US 2016/0378176 A1
(43) Pub. Date: Dec. 29, 2016

(54) Hand And Body Tracking With Mobile Device-Based Virtual Reality Head-Mounted Display

(71) Applicant: MediaTek Inc., Hsinchu (TW)

(72) Inventors: Da-Shan Shiu, Taipei (TW); Kai-Mau Chang, New Taipei City (TW)

(21) Appl. No.: 14/748,231

(22) Filed: Jun. 24, 2015

(51) Int. Cl. G06F 3/01; H04N 5/232; G06T 17/00; H04N 5/347; G06T 19/00; G02B 13/04

(52) U.S. Cl. CPC G06F 3/011; G06T 19/006; G02B 13/04; G06T 17/00; H04N 5/347; H04N 5/23245

(57) ABSTRACT

A head-mounted display (HMD) may include a mobile device that includes a display unit, at least one sensing unit and a processing unit. The at least one sensing unit may be configured to detect a presence of an object. The processing unit may be configured to receive data associated with the detecting from the at least one sensing unit, and determine one or more of a position, an orientation and a motion of the object based at least in part on the received data. The HMD may also include an eyewear piece that includes a holder and a field of view (FOV) enhancement unit. The holder may be wearable by a user on a forehead thereof to hold the mobile device in front of eyes of the user. The FOV enhancement unit may be configured to enlarge or redirect a FOV of the at least one sensing unit.

### TECHNICAL FIELD

The inventive concept described herein is generally related to head-mounted display and, more particularly, to techniques with respect to hand and body tracking with mobile device-based virtual reality head-mounted display.

### BACKGROUND

Unless otherwise indicated herein, approaches described in this section are not prior art to the claims listed below and are not admitted to be prior art by inclusion in this section.

In a smartphone-based Virtual Reality (VR) head-mounted display (HMD) application, a user typically wears a HMD that is comprised of a smartphone in some kind of a phone holder. The smartphone provides display functionality and can additionally provide head position tracking and even graphics and multimedia rendering functionalities.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of a configuration for realizing an implementation of the present disclosure.

FIG. 2 is a diagram of a configuration for realizing another implementation of the present disclosure.

FIG. 3 is a diagram of a configuration for realizing another implementation of the present disclosure.

FIG. 4 is a diagram of a configuration for realizing yet another implementation of the present disclosure.

FIG. 5 is a diagram of a configuration for realizing still another implementation of the present disclosure.

FIG. 6 is a diagram of a configuration for realizing a further implementation of the present disclosure.

FIG. 7 is a diagram of a scenario in which a hand of a user is outside the field of view of a camera in accordance with an implementation of the present disclosure.

FIG. 8 is a diagram of a scenario in which a hand of a user is inside the field of view of a camera in accordance with an implementation of the present disclosure.

FIG. 9 is a diagram of a scenario in which a hand of a user is inside the field of view of a camera in accordance with another implementation of the present disclosure.

FIG. 10 is a diagram of a scenario in which a hand of a user is inside the field of view of a camera in accordance with yet another implementation of the present disclosure.

FIG. 11 is a diagram of pre-processing recognition of a hand using depth information in accordance with an implementation of the present disclosure.

FIG. 12 is a diagram of depth information being provided by a time-of-flight camera in accordance with an implementation of the present disclosure.

FIG. 13 is a diagram of a mobile device with stereo vision using dual cameras in accordance with an implementation of the present disclosure.

FIG. 14 shows determination of stereopsis-depth through disparity measurement.

### DETAILED DESCRIPTION OF PREFERRED IMPLEMENTATIONS

### Overview

Implementations of the present disclosure may be applied to or otherwise implemented in any suitable mobile device. Thus, even though the term “smartphone” is used in the description below, implementations of the present disclosure are applicable to other suitable mobile devices (e.g., tablet computers, phablets and portable computing devices).

As VR is an emerging feature in the consumer market, both a main processing machine and a HMD are key components of a VR system. Present day high-end smartphones/mobile devices are typically equipped with amazingly good quality display, powerful central processing unit (CPU) and graphics processing unit (GPU), and various capable sensors. By putting such a smartphone/mobile device in a suitable holder, a resultant HMD is a holistic integrated VR system, providing a variety of display, computation, and head tracking functionalities.

Nowadays a typical smartphone (or, generally, mobile device) is equipped with various kinds of sensors to provide interesting interaction between smartphone and real-world analog signals through a plethora of smartphone applications. A brief description of a number of sensors equipped on or capable of being added to a smartphone is provided below.

Most, if not all, of the smartphones currently on the market are equipped with a single main camera. Some smartphones are equipped with dual main cameras which are mainly used for re-focusing a shot. A time-of-flight camera, also referred to as depth camera, may be used in conjunction with a smartphone (or, generally, with a portable electronic device) to provide depth information, e.g., for three-dimensional (3D) environment model creation and 3D object scanning. An ultrasound sensor may be used for touchless or gesture controlling. A proximity sensor may be used to turn on and off a switch or panel when the smartphone is in a talk position. An ambient light sensor may be used to dynamically control panel backlight of the smartphone to provide better reading experience. A motion sensor may be used to detect the orientation and motion of the smartphone. A barometric sensor may be used to report the altitude of the smartphone.

Existing approaches of hand and body tracking for VR typically involve the user wearing body suits, special markers or active sensors on the hand or body. As will be described later, implementations of the present disclosure are different from existing approaches in that the present disclosure promotes the re-use of existing sensor(s), e.g., cameras, already equipped in a smartphone for hand and body tracking.

There are various off-the-shelf approaches of hand and body tracking. Some can sense free hands such as, for example, leap motion and nimble sense. Some require users to be equipped with wearables such as, for example, elbow band, gloves, rings and the like. Both leap motion and nimble sense utilize one or more cameras and infrared (IR) light to capture and sense motion of hand(s) of the user. Currently these are available as aftermarket accessories. When used with a smartphone/mobile device-based VR system, both the camera(s) and the IR lighting are external to the VR system. Undesirably, the user would worry about the integration of software driver(s), applications and VR applications/games, in addition to the compatibility of mechanical attachment structures. Using approaches of this kind, additional costs, weight and size would be incurred.

An elbow band utilizes conductive electrocardiogram (EKG) sensors and collaborate with inertia sensors to track the motion of arms and hands of the user. An additional major drawback is that EKG sensors, which conductively measure tiny current variations, require a physical contact between the electrodes of the sensor and the skin of the user. Accordingly, such an approach is not applicable if the user wishes to wear a long-sleeve shirt. Ring-type and glove-type approaches usually utilize inertia sensors on the fingers of the user to sensor motion of the whole hand. This may be annoying if the user would be required to put the ring or glove on and take it off frequently. Rings and gloves are separate and small accessories that are not physically attached to the HMD, thus the need for carrying and finding them may be burdensome to the user.

The ability to track position (x/y/z) and orientation (yaw/pitch/roll) of the hand(s) of a user of VR applications enables many interesting things. For example, hand tracking allows a natural and intuitive way to interact with virtual object and environment, e.g., to grab or release object in the VR world. Hand tracking also provides another option to choose between menu items and other user-interface items, e.g., to touch a virtual bottom in the air. As many games have demonstrated, continuous tracking of the location of hand and body of the user tends to be useful and interesting in fitness and sport games, e.g., swinging a virtual baseball bat at a ball or throw a virtual air basketball.

One issue with conventional HMDs is that the HMD tends to block the normal view of the user. With the HMD blocking the normal view of the user, traditional control mechanisms such as keyboard, mouse, and game pad can be difficult to use. In such applications, hand and body tracking can be advantageous. Various means of sensing the position, orientation and motion of hands and body of the user may be deployed. Some of the means operate based on the principles of vision, inertia sensing, or ultrasound sensing. It is a common practice to mount additional sensors to sense the hands and body of the user on the smartphone holder or on some external platform. The sensors then relay the observations to a main host through separate connections.

In some systems, a user is required to wear or hold certain devices, such as magnetic field radiating wrist bands, to enable sensing. Besides, some sensing devices are aftermarket add-ons, and they are not designed specifically for use with a given HMD. For example, sensors such as infrared sensors, inertia sensors, electromyography (EMG)-inertia sensors, magnetic sensors and bending sensors may be add-on accessories to a given HMD that may or may not be purchased/used by the user. Meanwhile, certain VR applications require the user to be equipped with sensors or magnets to enable sensing. That is, on the one hand, users desire hand and body interaction with the VR application while, on the other hand, it is difficult for developers of VR applications to predict what kind of HMD gear and add-ons users might have.

To address the above-described issue, implementations of the present disclosure employ one or more commonly-found sensors, whenever applicable, to realize hand tracking and/or body tracking for a smartphone/mobile device-based VR system. For instance, implementations of the present disclosure may utilize one or more of the following: a single main camera of the smartphone for image sensing, dual back cameras of the smartphone for image sensing, a depth camera (which may operate based on time-of-flight principles) and an ultrasound sensor for object detection.

In at least some implementations of the present disclosure, the field of view (FOV) of the image sensor(s) and/or depth sensor(s) is redirected toward the body part of interests, such as the hands in front of the user's body. Subsequent processing may be performed to derive useful information, e.g., hand position, hand orientation and/or direction of hand motion, which is needed by a VR application. Implementations of the present disclosure also utilize a close collaboration between the VR application and the sensors in order to optimally control the sensors in a real-time fashion such as, for example, for restricting a possible area for ultrasound scanning.

With respect to hand and body tracking for VR, there are a number of issues. Firstly, external sensors and/or external processors are usually necessary, and this is undesirable. As long as there is doubt as to whether there are sufficient number of users having suitable hand/body tracking accessories, it is difficult for a developer or vendor to design VR applications, e.g., games, which require hand and/or body tracking. Secondly, to enable hand/body tracking, it is usually necessary for the user to wear a tracking device such as band(s), glove(s) or even smart nail(s) on the hand(s) and/or arm(s) of the user. Moreover, as tracking devices emit and/or receive electromagnetic (EM) waves, EM interference may be a problem. For image-based hand/body tracking approaches, the background of the image is often required to have a certain property such as, for example, having a color that is different from the color of the skin of the user.

Implementations of the present disclosure address afore-mentioned issues while providing a number of benefits. First of all, the cost of ownership is reduced with implementations of the present disclosure. For instance, existing sensors of the smartphone, i.e., those sensors that come equipped on the smartphone, are utilized for the additional purpose of hand/body tracking. Thus, there is no additional cost necessary, e.g., for acquiring EKG sensor(s), inertia sensor(s), or any add-on to sensors. Additionally, implementations of the present disclosure provide a much simpler configuration compared to existing approaches. This is because there are no additional accessories required. For example, in at least some implementations, hand and body tracking may be based on images captured by cameras of the smartphone. Since it is the camera already equipped on the smartphone that is used to track the position, orientation and/or motion of the hand and/or body, there is no need to worry about system compatibility and battery life of accessories. Moreover, implementations of the present disclosure are much more comfortable to use from the perspective of the user. With implementations of the present disclosure, there is no need for the user to put on or hold onto some additional device(s) or accessory/accessories. For example, in at least some implementations, one or more cameras of the smartphone may be used for tracking the position, orientation and/or motion of hand and/or body of the user with novel algorithm and advanced digital image processing technique. The user is not required to press any button (which is usually found on conventional gamepads) to control operation of a VR application. Furthermore, implementations of the present disclosure provide holistic and integrated optimization of platform performance. With the holistic design, an application developer can do much more real-time integration between a particular application and the sensor resources of the smartphone.

It is noteworthy that a particular challenge for smartphone/mobile device-based HMD is that, while the smartphone sensors are observing the hands and the body, the position of the smartphone itself—which is worn on the player's head—relative to the virtual world often is in motion. The observed hand and/or body position relative to the smartphone not only is attributable to the hand and body motion with respect to the virtual world but also to the head motion of the user. Given that most likely VR applications require the pure hand and/or body motion, any relative motion attributable to the head needs to be eliminated or otherwise canceled. That is, cancellation of unwanted information of irrelevant motion is a critical step in the use of smartphone sensors for hand and body tracking. The source of information about the head motion may be the one or more sensors that are already present on a smartphone-based HMD. Alternatively or additionally, the source of information about the head motion may be one or more sensors that are located external to the HMD.

Regarding providing a much simpler configuration, VR is a highly interactive form of experience. If a hypothetical content can only be experienced with certain external aftermarket accessories, then from the perspective of a content creator the total addressable market size is reduced. This would reduce the incentive for the content creator, potentially to the point that the hypothetical content is never created. By leveraging the resources of a smartphone at virtually no cost, implementations of the present disclosure guarantee the availability of hand and body tracking functionalities.

Thus, from the perspective of implementations of the present disclosure, the sensors used for hand and body tracking are readily embedded in the smartphone. For instance, in at least some implementations of the present disclosure, one or more cameras and/or ultrasound sensors already present in a smartphone may be utilized for hand and body tracking. This provides a huge incentive to application developers as developers would not need to worry anymore about what kind of tracking devices and sensors users may have. As existing sensors of the smartphone are utilized for hand and body tracking, application developers can regard the tracking functionality to be always present and thus can freely create more and more interesting applications that require hand and body tracking. As for the user, there is no additional cost or aftermarket purchase necessary to enable hand and body tracking features, which would become a “for sure” feature as common as taking a picture.

### Example Implementations

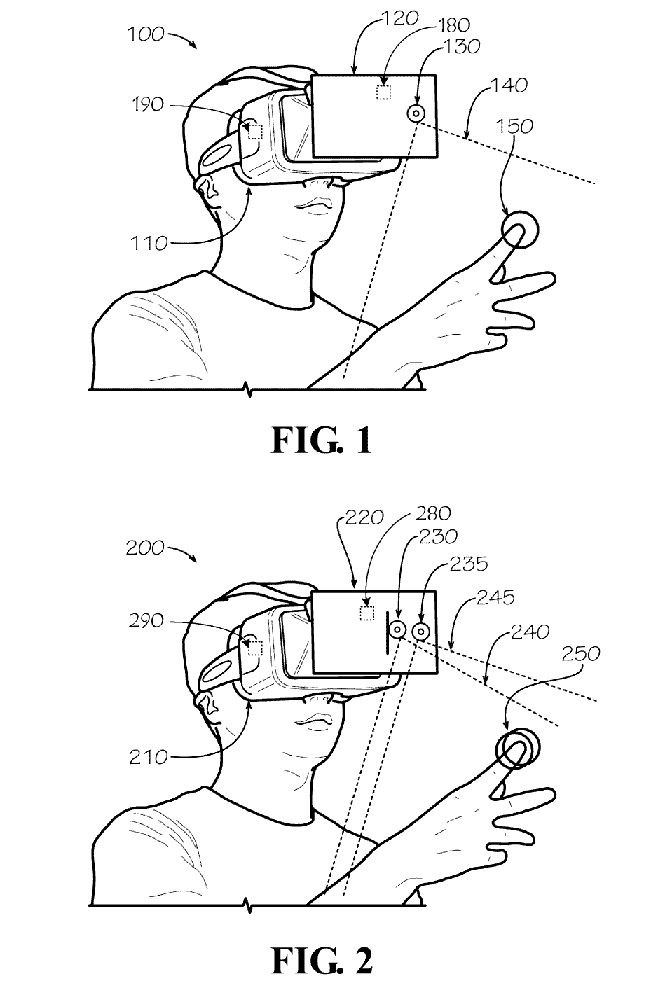

Implementations of the present disclosure may be realized in a number of VR configurations including, but not limited to, the configurations shown in FIG. 1-FIG. 6.

FIG. 1 shows a configuration 100 for realizing an implementation of the present disclosure. As shown in FIG. 1, configuration 100 includes an eyewear piece 110 worn by a user and a mobile device 120 (e.g., a smartphone) having a first primary side facing the user and a second primary side opposite the first primary side. Mobile device 120 has a display unit (not shown) on the first primary side, facing eyes of the user, and at least one sensing unit (e.g., a camera 130) on the second primary side. Camera 130 has a FOV 140 and is configured to detect a presence of an object (e.g., hand 150 of the user). Mobile device 120 also includes a processing unit that is configured to control operations of the display unit and the camera 130. The processing unit may be also configured to receive data associated with the detecting from the camera 130. The processing unit may be further configured to determine one or more of a position, an orientation and a motion of the hand 150 based at least in part on the received data. For instance, mobile device 120 may include a motion sensor 180, e.g., a gyroscope or any suitable electro-mechanical circuitry capable of determining motion, acceleration and/or orientation. Motion sensor 180 may sense a motion of mobile device 120 and output a motion sensing signal indicative of the sensed motion. Correspondingly, processing unit of mobile device 120 may receive the motion sensing signal from motion sensor 180 and compensate for the sensed motion in a VR application. Eyewear piece 110 may include a holder that is wearable by the user on a forehead thereof, and configured to hold mobile device 120 in front of the eyes of the user. Additionally or alternatively, eyewear piece 110 may include a motion sensor 190, e.g., a gyroscope or any suitable electro-mechanical circuitry capable of determining motion, acceleration and/or orientation. Motion sensor 190 may sense a motion of eyewear piece 110 and output a motion sensing signal indicative of the sensed motion. Correspondingly, processing unit of mobile device 120 may receive the motion sensing signal from motion sensor 190, e.g., wirelessly, and compensate for the sensed motion in a VR application.

FIG. 2 shows a configuration 200 for realizing another implementation of the present disclosure. As shown in FIG. 2, configuration 200 includes an eyewear piece 210 worn by a user and a mobile device 220 (e.g., a smartphone) having a first primary side facing the user and a second primary side opposite the first primary side. Mobile device 220 has a display unit (not shown) on the first primary side, facing eyes of the user, and at least one sensing unit (e.g., first camera 230 and second camera 235) on the second primary side. Camera 230 has a FOV 240 and is configured to detect a presence of an object (e.g., hand 250 of the user). Camera 235 has a FOV 245 and is also configured to detect the presence of the object (e.g., hand 250 of the user). Mobile device 220 also includes a processing unit that is configured to control operations of the display unit, first camera 230 and second camera 235. The processing unit may be also configured to receive data associated with the detecting from first camera 230 and second camera 235. The processing unit may be further configured to determine one or more of a position, an orientation and a motion of the hand 250 based at least in part on the received data. For instance, mobile device 220 may include a motion sensor 280, e.g., a gyroscope or any suitable electro-mechanical circuitry capable of determining motion, acceleration and/or orientation. Motion sensor 280 may sense a motion of mobile device 220 and output a motion sensing signal indicative of the sensed motion. Correspondingly, processing unit of mobile device 220 may receive the motion sensing signal from motion sensor 280 and compensate for the sensed motion in a VR application. Eyewear piece 210 may include a holder that is wearable by the user on a forehead thereof, and configured to hold mobile device 220 in front of the eyes of the user. Additionally or alternatively, eyewear piece 210 may include a motion sensor 290, e.g., a gyroscope or any suitable electro-mechanical circuitry capable of determining motion, acceleration and/or orientation. Motion sensor 290 may sense a motion of eyewear piece 210 and output a motion sensing signal indicative of the sensed motion. Correspondingly, processing unit of mobile device 220 may receive the motion sensing signal from motion sensor 290, e.g., wirelessly, and compensate for the sensed motion in a VR application.

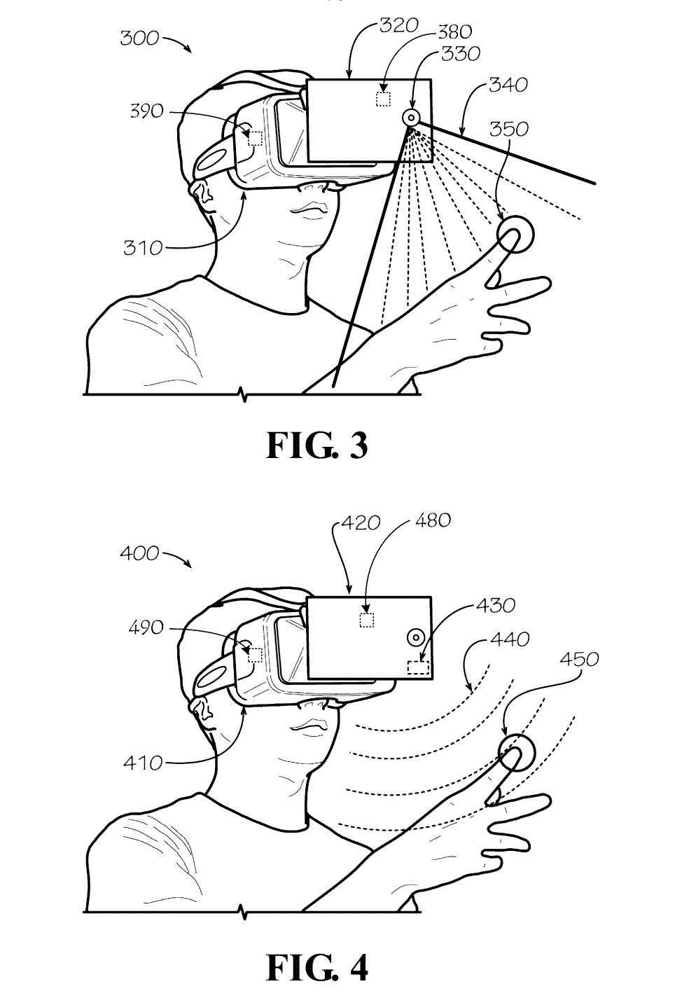

FIG. 3 shows a configuration 300 for realizing another implementation of the present disclosure. As shown in FIG. 3, configuration 300 includes an eyewear piece 310 worn by a user and a mobile device 320 (e.g., a smartphone) having a first primary side facing the user and a second primary side opposite the first primary side. Mobile device 320 has a display unit (not shown) on the first primary side, facing eyes of the user, and at least one sensing unit (e.g., a depth camera 330) on the second primary side. Depth camera 330 has a FOV 340 and is configured to detect a presence of an object (e.g., hand 350 of the user). Mobile device 320 also includes a processing unit that is configured to control operations of the display unit and depth camera 330. The processing unit may be also configured to receive data associated with the detecting from depth camera 330. The processing unit may be further configured to determine one or more of a position, an orientation and a motion of the hand 350 based at least in part on the received data. For instance, mobile device 320 may include a motion sensor 380, e.g., a gyroscope or any suitable electro-mechanical circuitry capable of determining motion, acceleration and/or orientation. Motion sensor 380 may sense a motion of mobile device 320 and output a motion sensing signal indicative of the sensed motion. Correspondingly, processing unit of mobile device 320 may receive the motion sensing signal from motion sensor 380 and compensate for the sensed motion in a VR application. Eyewear piece 310 may include a holder that is wearable by the user on a forehead thereof, and configured to hold mobile device 320 in front of the eyes of the user. Additionally or alternatively, eyewear piece 310 may include a motion sensor 390, e.g., a gyroscope or any suitable electro-mechanical circuitry capable of determining motion, acceleration and/or orientation. Motion sensor 390 may sense a motion of eyewear piece 310 and output a motion sensing signal indicative of the sensed motion. Correspondingly, processing unit of mobile device 320 may receive the motion sensing signal from motion sensor 390, e.g., wirelessly, and compensate for the sensed motion in a VR application.

FIG. 4 shows a configuration 400 for realizing yet another implementation of the present disclosure. As shown in FIG. 4, configuration 400 includes an eyewear piece 410 worn by a user and a mobile device 420 (e.g., a smartphone) having a first primary side facing the user and a second primary side opposite the first primary side. Mobile device 420 has a display unit (not shown) on the first primary side, facing eyes of the user, and at least one sensing unit (e.g., an ultrasound sensor 430) on the second primary side. Ultrasound sensor 430 is configured to emit ultrasound waves 440 to detect a presence of an object (e.g., hand 450 of the user). Mobile device 420 also includes a processing unit that is configured to control operations of the display unit and ultrasound sensor 430. The processing unit may be also configured to receive data associated with the detecting from ultrasound sensor 430. The processing unit may be further configured to determine one or more of a position, an orientation and a motion of the hand 450 based at least in part on the received data. For instance, mobile device 420 may include a motion sensor 480, e.g., a gyroscope or any suitable electro-mechanical circuitry capable of determining motion, acceleration and/or orientation. Motion sensor 480 may sense a motion of mobile device 420 and output a motion sensing signal indicative of the sensed motion. Correspondingly, processing unit of mobile device 420 may receive the motion sensing signal from motion sensor 480 and compensate for the sensed motion in a VR application. Eyewear piece 410 may include a holder that is wearable by the user on a forehead thereof, and configured to hold mobile device 420 in front of the eyes of the user. Additionally or alternatively, eyewear piece 410 may include a motion sensor 490, e.g., a gyroscope or any suitable electro-mechanical circuitry capable of determining motion, acceleration and/or orientation. Motion sensor 490 may sense a motion of eyewear piece 410 and output a motion sensing signal indicative of the sensed motion. Correspondingly, processing unit of mobile device 420 may receive the motion sensing signal from motion sensor 490, e.g., wirelessly, and compensate for the sensed motion in a VR application.

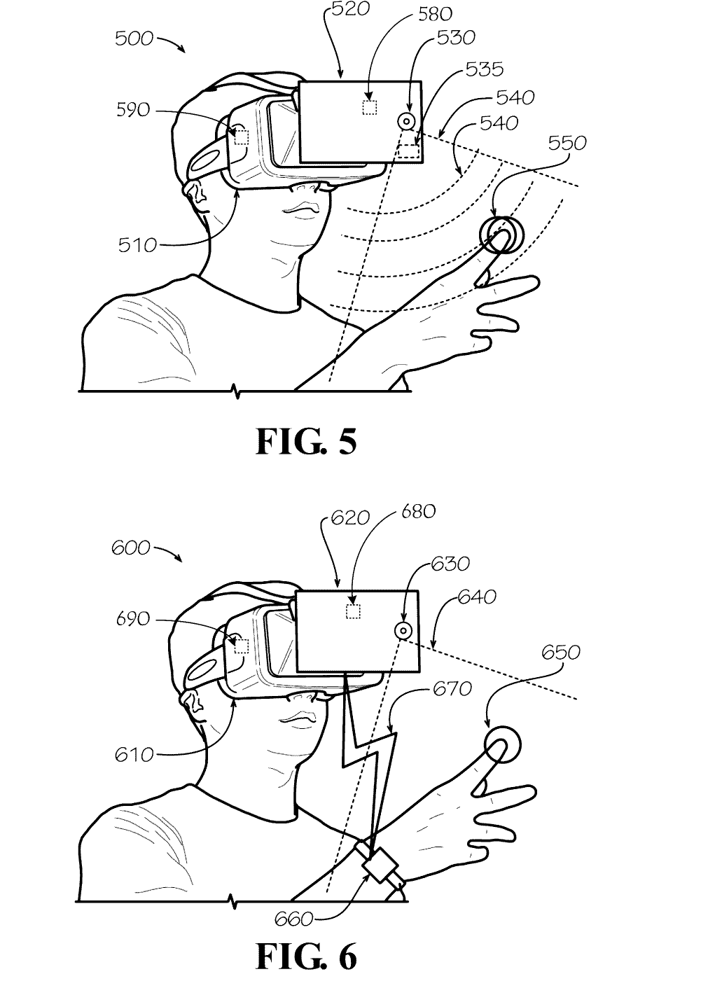

FIG. 5 shows a configuration 500 for realizing still another implementation of the present disclosure. As shown in FIG. 5, configuration 500 includes an eyewear piece 510 worn by a user and a mobile device 520 (e.g., a smartphone) having a first primary side facing the user and a second primary side opposite the first primary side. Mobile device 520 has a display unit (not shown) on the first primary side, facing eyes of the user, and at least one sensing unit (e.g., camera 530 and ultrasound sensor 535) on the second primary side. Camera 530 has a FOV 540 and is configured to detect a presence of an object (e.g., hand 550 of the user). Ultrasound sensor 535 is configured to emit ultrasound waves 545 to detect the presence of the object (e.g., hand 550 of the user). Mobile device 520 also includes a processing unit that is configured to control operations of the display unit, camera 530 and ultrasound sensor 535. The processing unit may be also configured to receive data associated with the detecting from camera 530 and ultrasound sensor 535. The processing unit may be further configured to determine one or more of a position, an orientation and a motion of the hand 550 based at least in part on the received data. For instance, mobile device 520 may include a motion sensor 580, e.g., a gyroscope or any suitable electro-mechanical circuitry capable of determining motion, acceleration and/or orientation. Motion sensor 580 may sense a motion of mobile device 520 and output a motion sensing signal indicative of the sensed motion. Correspondingly, processing unit of mobile device 520 may receive the motion sensing signal from motion sensor 580 and compensate for the sensed motion in a VR application. Eyewear piece 510 may include a holder that is wearable by the user on a forehead thereof, and configured to hold mobile device 520 in front of the eyes of the user. Additionally or alternatively, eyewear piece 510 may include a motion sensor 590, e.g., a gyroscope or any suitable electro-mechanical circuitry capable of determining motion, acceleration and/or orientation. Motion sensor 590 may sense a motion of eyewear piece 510 and output a motion sensing signal indicative of the sensed motion. Correspondingly, processing unit of mobile device 520 may receive the motion sensing signal from motion sensor 590, e.g., wirelessly, and compensate for the sensed motion in a VR application.

FIG. 6 shows a configuration 600 for realizing a further implementation of the present disclosure. As shown in FIG. 6, configuration 600 includes an eyewear piece 610 worn by a user and a mobile device 620 (e.g., a smartphone) having a first primary side facing the user and a second primary side opposite the first primary side. Mobile device 620 has a display unit (not shown) on the first primary side, facing eyes of the user, and at least one sensing unit (e.g., a camera 630) on the second primary side. Camera 630 has a FOV 640 and is configured to detect a presence of an object (e.g., hand 650 of the user). Mobile device 620 also includes a processing unit that is configured to control operations of the display unit and the camera 630. The processing unit may be also configured to receive data associated with the detecting from the camera 630. The processing unit may be further configured to determine one or more of a position, an orientation and a motion of the hand 650 based at least in part on the received data. For instance, mobile device 620 may include a motion sensor 680, e.g., a gyroscope or any suitable electro-mechanical circuitry capable of determining motion, acceleration and/or orientation. Motion sensor 680 may sense a motion of mobile device 620 and output a motion sensing signal indicative of the sensed motion. Correspondingly, processing unit of mobile device 620 may receive the motion sensing signal from motion sensor 680 and compensate for the sensed motion in a VR application. Eyewear piece 610 may include a holder that is wearable by the user on a forehead thereof, and configured to hold mobile device 620 in front of the eyes of the user. Additionally or alternatively, eyewear piece 610 may include a motion sensor 690, e.g., a gyroscope or any suitable electro-mechanical circuitry capable of determining motion, acceleration and/or orientation. Motion sensor 690 may sense a motion of eyewear piece 610 and output a motion sensing signal indicative of the sensed motion. Correspondingly, processing unit of mobile device 620 may receive the motion sensing signal from motion sensor 690, e.g., wirelessly, and compensate for the sensed motion in a VR application.

Mobile device 620 may further include a wireless communication unit configured to at least wirelessly receive a signal 670 from a wearable computing device 660 (e.g., smartwatch) worn by the user. The processing unit may be also configured to determine one or more of the position, the orientation and the motion of the hand 650 (or wrist of the user) based on the received data and the received signal 670.

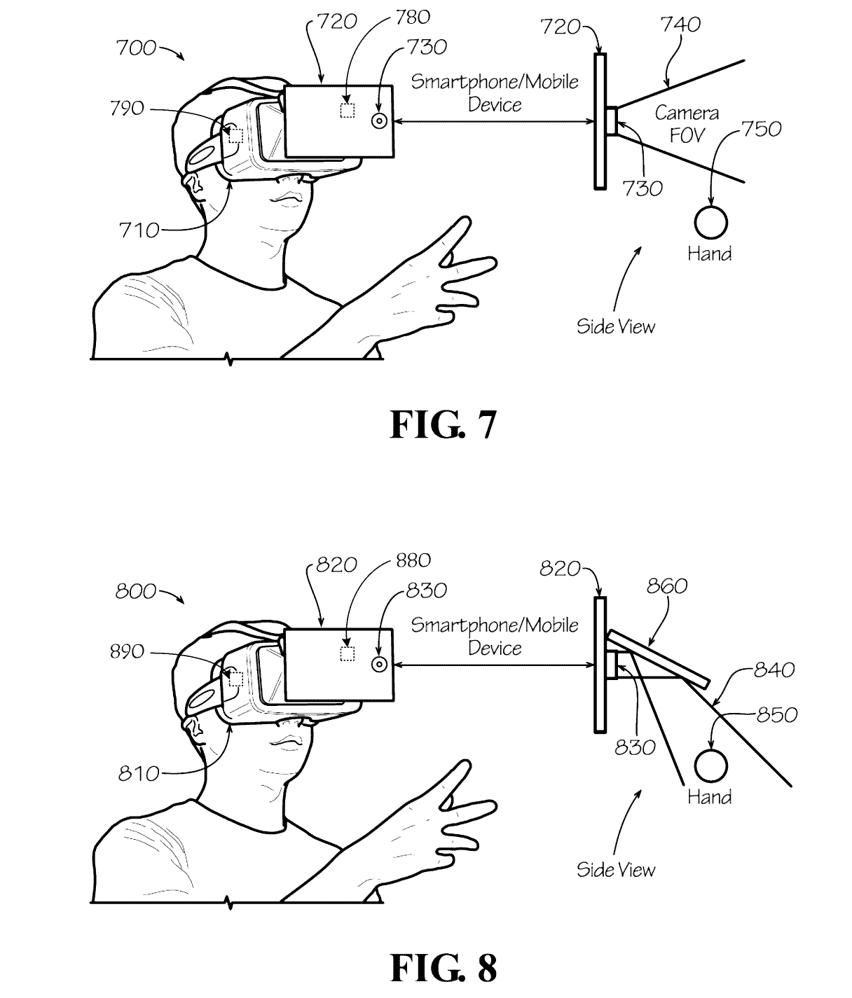

Implementations of the present disclosure reuse existing sensor(s) with which a smartphone (or, generally, a mobile device) is already equipped for the purpose of tracking of an object such as hand(s) and body part of a user. One challenge, however, is that the user's hand may be out of the general FOV of the camera of the smartphone, which is typically in the range of 60°˜80°, as shown in FIG. 7.

FIG. 7 shows a scenario 700 in which a hand of a user is outside the field of view of a camera in accordance with an implementation of the present disclosure. In scenario 700, the user wears a HMD which includes an eyewear piece 710 and a mobile device 720 (e.g., smartphone) having a first primary side facing the user and a second primary side opposite the first primary side. Mobile device 720 has a display unit (not shown) on the first primary side, facing eyes of the user, and at least one sensing unit (e.g., a camera 730) on the second primary side. Camera 730 has a FOV 740 and is configured to detect a presence of an object (e.g., hand 750 of the user). As shown in FIG. 7, hand 750 may, at times, be outside the FOV 740 of camera 730 such as, for example, when the user tilts or turns his head to look at a direction that is away from either or both of his hands.

Mobile device 720 may include a motion sensor 780, e.g., a gyroscope or any suitable electro-mechanical circuitry capable of determining motion, acceleration and/or orientation. Motion sensor 780 may sense a motion of mobile device 720 and output a motion sensing signal indicative of the sensed motion. Correspondingly, processing unit of mobile device 720 may receive the motion sensing signal from motion sensor 780 and compensate for the sensed motion in a VR application. Additionally or alternatively, eyewear piece 710 may include a motion sensor 790, e.g., a gyroscope or any suitable electro-mechanical circuitry capable of determining motion, acceleration and/or orientation. Motion sensor 790 may sense a motion of eyewear piece 710 and output a motion sensing signal indicative of the sensed motion. Correspondingly, processing unit of mobile device 720 may receive the motion sensing signal from motion sensor 790, e.g., wirelessly, and compensate for the sensed motion in a VR application.

One solution to address this issue is to use a reflective element, e.g., a mirror, installed at a certain angle in front of the camera of the smartphone, as shown in FIG. 8, to redirect the FOV of the camera so that the camera can detect, or “see”, the hands and at least a part of the body of the user.

FIG. 8 shows a scenario 800 in which a hand of a user is inside the field of view of a camera in accordance with an implementation of the present disclosure. In scenario 800, the user wears a HMD which includes an eyewear piece 810 and a mobile device 820 (e.g., smartphone) having a first primary side facing the user and a second primary side opposite the first primary side. Mobile device 820 has a display unit (not shown) on the first primary side, facing eyes of the user, and at least one sensing unit (e.g., a camera 830) on the second primary side. Camera 830 has a FOV 840 and is configured to detect a presence of an object (e.g., hand 850 of the user). In scenario 800, eyewear piece 810 also includes a FOV enhancement unit 860 configured to redirect FOV 840 of camera 830. FOV enhancement unit 860 may include a reflective element such as, for example, a plain mirror.

Mobile device 820 may include a motion sensor 880, e.g., a gyroscope or any suitable electro-mechanical circuitry capable of determining motion, acceleration and/or orientation. Motion sensor 880 may sense a motion of mobile device 820 and output a motion sensing signal indicative of the sensed motion. Correspondingly, processing unit of mobile device 820 may receive the motion sensing signal from motion sensor 880 and compensate for the sensed motion in a VR application. Additionally or alternatively, eyewear piece 810 may include a motion sensor 890, e.g., a gyroscope or any suitable electro-mechanical circuitry capable of determining motion, acceleration and/or orientation. Motion sensor 890 may sense a motion of eyewear piece 810 and output a motion sensing signal indicative of the sensed motion. Correspondingly, processing unit of mobile device 820 may receive the motion sensing signal from motion sensor 890, e.g., wirelessly, and compensate for the sensed motion in a VR application.

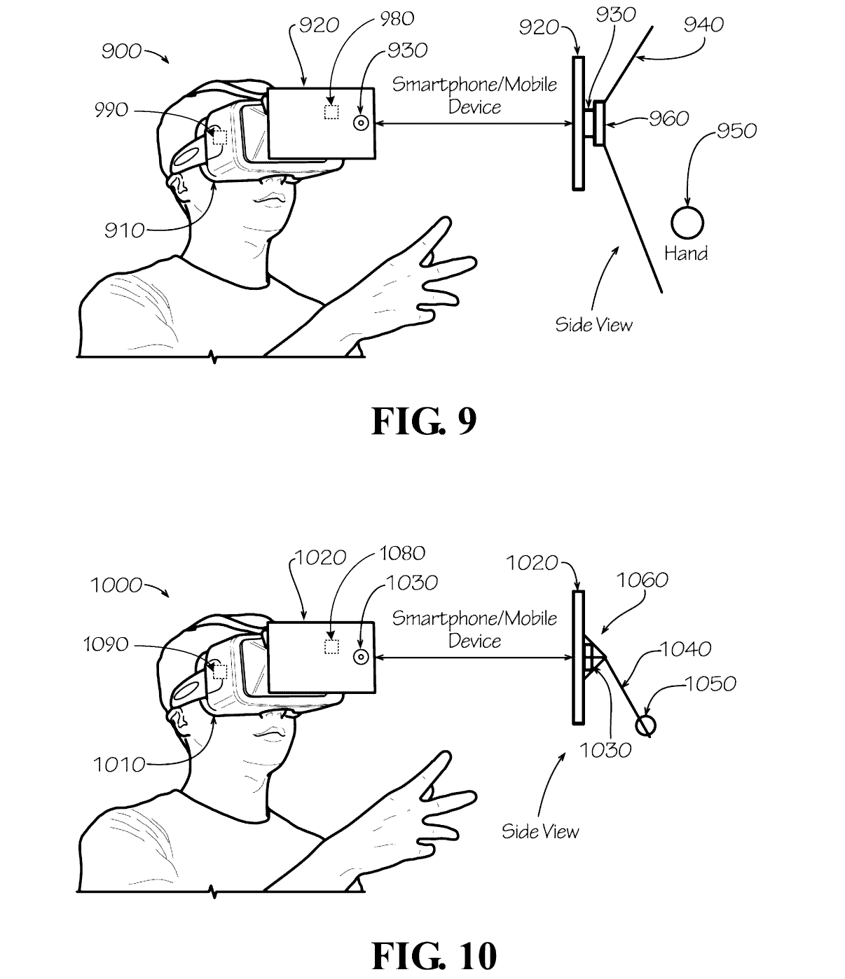

Another solution is to install a wide angle lens, or a fisheye lens, in front of the camera to increase the FOV of the camera so that the camera can detect, or “see”, the hands and at least a part of the body of the user, as shown in FIG. 9.

FIG. 9 shows a scenario 900 in which a hand of a user is inside the field of view of a camera in accordance with another implementation of the present disclosure. In scenario 900, the user wears a HMD which includes an eyewear piece 910 and a mobile device 920 (e.g., smartphone) having a first primary side facing the user and a second primary side opposite the first primary side. Mobile device 920 has a display unit (not shown) on the first primary side, facing eyes of the user, and at least one sensing unit (e.g., a camera 930) on the second primary side. Camera 930 has a FOV 940 and is configured to detect a presence of an object (e.g., hand 950 of the user). In scenario 900, eyewear piece 910 also includes a FOV enhancement unit 960 configured to increase FOV 940 of camera 930. FOV enhancement unit 960 may include a wide angle lens or a fisheye lens.

Mobile device 920 may include a motion sensor 980, e.g., a gyroscope or any suitable electro-mechanical circuitry capable of determining motion, acceleration and/or orientation. Motion sensor 980 may sense a motion of mobile device 920 and output a motion sensing signal indicative of the sensed motion. Correspondingly, processing unit of mobile device 920 may receive the motion sensing signal from motion sensor 980 and compensate for the sensed motion in a VR application. Additionally or alternatively, eyewear piece 910 may include a motion sensor 990, e.g., a gyroscope or any suitable electro-mechanical circuitry capable of determining motion, acceleration and/or orientation. Motion sensor 990 may sense a motion of eyewear piece 910 and output a motion sensing signal indicative of the sensed motion. Correspondingly, processing unit of mobile device 920 may receive the motion sensing signal from motion sensor 990, e.g., wirelessly, and compensate for the sensed motion in a VR application.

A different solution is to install an optical prism in front of the camera to redirect the FOV of the camera so that the camera can detect, or “see”, the hands and at least a part of the body of the user, as shown in FIG. 10.

FIG. 10 shows a scenario 1000 in which a hand of a user is inside the field of view of a camera in accordance with yet another implementation of the present disclosure. In scenario 1000, the user wears a HMD which includes an eyewear piece 1010 and a mobile device 1020 (e.g., smartphone) having a first primary side facing the user and a second primary side opposite the first primary side. Mobile device 1020 has a display unit (not shown) on the first primary side, facing eyes of the user, and at least one sensing unit (e.g., a camera 1030) on the second primary side. Camera 1030 has a FOV 1040 and is configured to detect a presence of an object (e.g., hand 1050 of the user). In scenario 1000, eyewear piece 1010 also includes a FOV enhancement unit 1060 configured to redirect FOV 1040 of camera 1030. FOV enhancement unit 1060 may include an optical prism.

Mobile device 1020 may include a motion sensor 1080, e.g., a gyroscope or any suitable electro-mechanical circuitry capable of determining motion, acceleration and/or orientation. Motion sensor 1080 may sense a motion of mobile device 1020 and output a motion sensing signal indicative of the sensed motion. Correspondingly, processing unit of mobile device 1020 may receive the motion sensing signal from motion sensor 1080 and compensate for the sensed motion in a VR application. Additionally or alternatively, eyewear piece 1010 may include a motion sensor 1090, e.g., a gyroscope or any suitable electro-mechanical circuitry capable of determining motion, acceleration and/or orientation. Motion sensor 1090 may sense a motion of eyewear piece 1010 and output a motion sensing signal indicative of the sensed motion. Correspondingly, processing unit of mobile device 1020 may receive the motion sensing signal from motion sensor 1090, e.g., wirelessly, and compensate for the sensed motion in a VR application.

In at least some implementations of the present disclosure, hand tracking may involve a number of operations including, but not limited to, picture taking of a hand of a user, image pre-processing, hand model construction and hand motion recognition.

With respect to picture taking, in general smartphone cameras are designed to produce still images and videos of high sharpness and/or resolution, instead of “good enough” input information for hand and body tracking, e.g., for VR applications. In other words, a traditional camera sensor of a smartphone (or, generally, a mobile device) would likely consume the mobile battery of the smartphone too fast for continuous use. As a result, implementations of the present disclosure tailor the control of existing camera(s) of a smartphone for “tracking photography”, for which higher frame rate is needed to record every motion made by the user to promptly reflect in the VR world information related to the position, orientation and/or motion of a hand or body of the user.

In at least some implementations of the present disclosure, frame rate, or the number of frames per second (FPS), of the camera may be adjusted, or increased, to match that of panel refresh, e.g., 60 Hz. Moreover, an image of low resolution, e.g., 640×480, may deliver performance that is acceptable for object tracking and computation. Furthermore, implementations of the present disclosure may adopt 2×2 or 4×4 pixel binning or partial pixel sub-sampling to provide an effective way to save power. Additionally, implementations of the present disclosure may turn off or otherwise deactivate the function of auto-focus of the camera, depending on the tracking algorithm in use, for further power saving.

One issue with reusing the camera of a smartphone or mobile device to realize additional hand/body tracking is the inducing of additional current consumption. However, with “tracking photography” properly configured the battery of the smartphone or mobile device would not be drained rapidly. That is, “tracking photography” may be defined in detail for optimized power efficiency for the smartphone or mobile device. For instance, an image signal processor (ISP) of the smartphone or mobile device may be designed to provide dual modes to realize implementations of the present disclosure to fulfill different photography requirements. One mode may be optimized for general photography and the other mode may be optimized for continuous tracking, analysis and decoding of information related to hand/body tracking in a power-efficient manner.

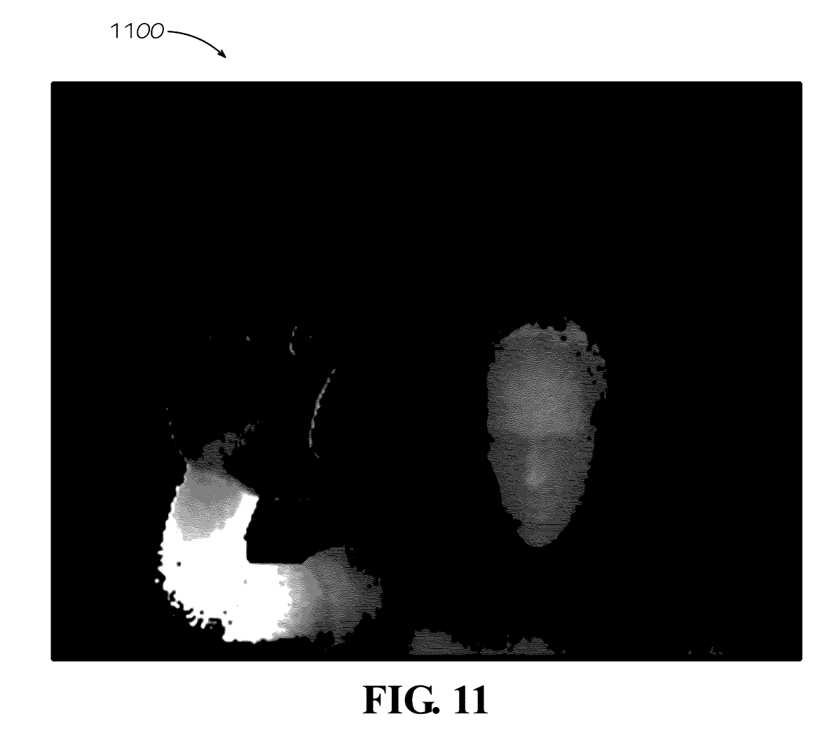

With respect to image pre-processing, skin color filtering is a common method for using a visible-light camera sensor of a smartphone or mobile device to discard pixel information that is useless for a particular application. Discarding useless pixel information in advance may greatly help reduce computation complexity. Although this is a simple and straightforward method, however, it is also sensitive to ambient light which may cause the skin color of the user to change. To mitigate the issue with the ambient light, implementations of the present disclosure may use depth information, or depth map, to pre-process filtering for real-time 3D motion recognition. With depth information for pre-processing recognition of a hand and body in the air becomes easier, as shown in FIG. 11.

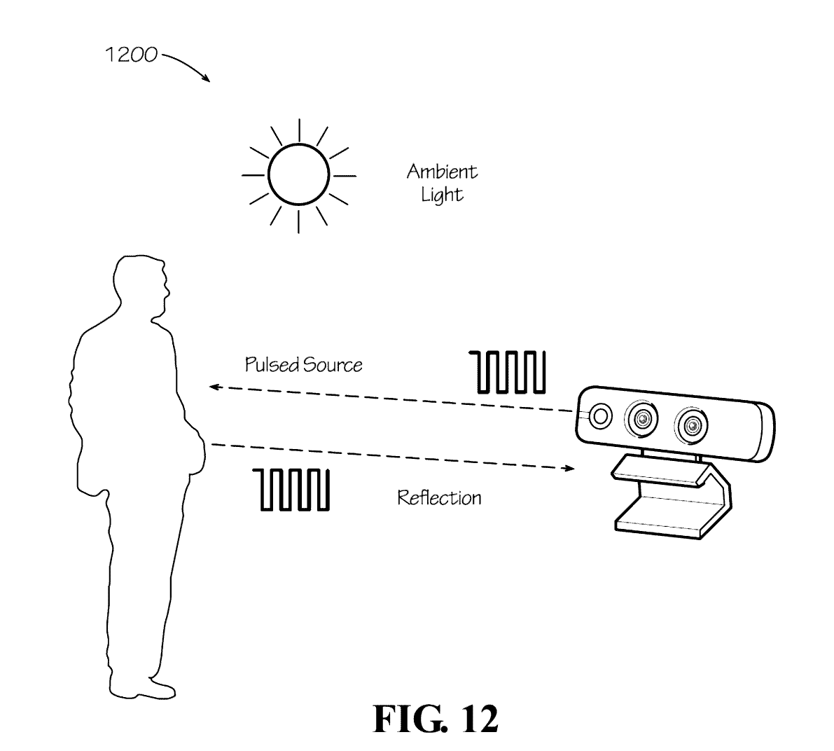

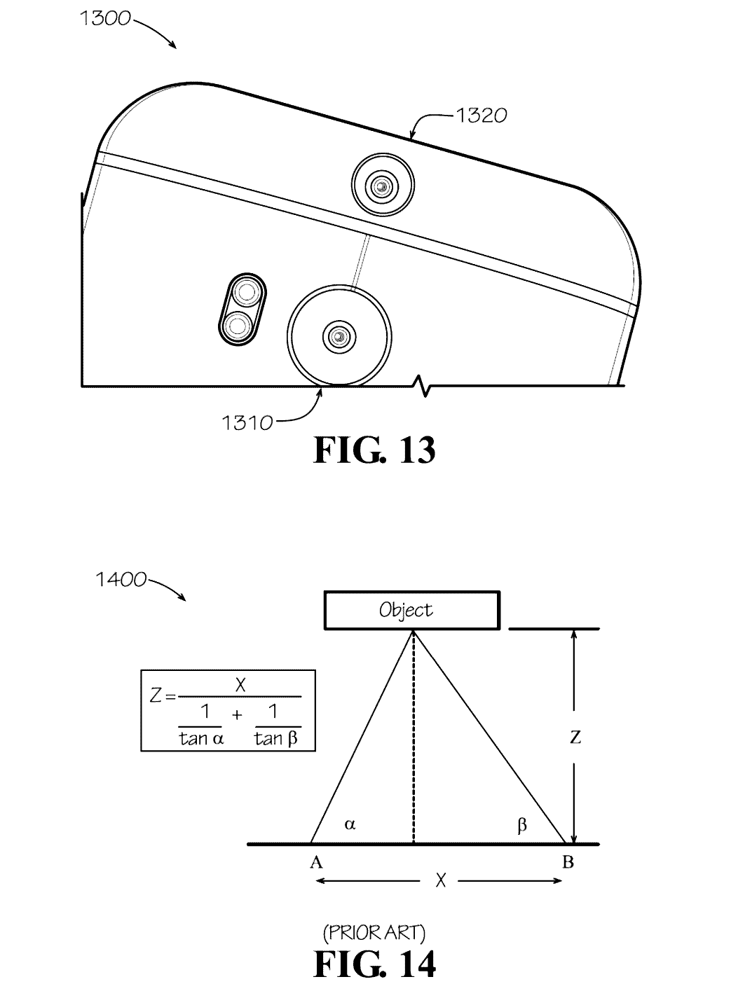

Depth information may be delivered by a time-of-flight camera, as shown in FIG. 12, or generated with stereoscopic images. Stereoscopic images may be taken by dual vision cameras, as shown in FIG. 13, that are separated from each other by a certain distance to simulate disparity, in a physical arrangement similar to the human eyes. Given a point-like object in space, the separation between the two cameras will lead to measurable disparity of the position of the object in images of the two cameras. Using a simple pin-hole camera model, the object position in each image may be computed, represented by angles α and β. With these angles known the depth, z, may be computed, as shown in FIG. 14.

With respect to hand model construction and hand motion recognition, it is expected that the processor(s) of a smartphone or mobile device presently on the market can perform complex image processing while running VR sessions simultaneously.

In at least some implementations of the present disclosure in which the head of the user is expected to tilt a lot, resulting in the hand(s) of the user being outside of the FOV of the camera of the smartphone or mobile device, the camera may be used in conjunction with another mechanism for hand tracking. For instance, the user may wear a smartwatch (or, generally, a wearable computing device) on the wrist for hand (wrist) tracking as the smartwatch or wearable computing device may transmit periodic or real-time location information to the smartphone or mobile device. When the hands can be seen, any drift may be corrected.

### Highlight of Features

Select features of implementations of the present disclosure are provided below in view of FIG. 1-FIG. 14 as well as description thereof.

In one aspect, a HMD may include an eyewear piece. The eyewear piece may be wearable on or around the forehead of a user similar to how a pair of goggles are typically worn. The eyewear piece may include a holder and a FOV enhancement unit. The holder may be wearable by a user on a forehead thereof, the holder configured to hold a mobile device in front of eyes of the user. The FOV enhancement unit may be configured to enlarge or redirect a FOV of one or more sensing units of the mobile device when the mobile device is held by the holder.

In at least some implementations, the FOV enhancement unit may include a reflective element.

In at least some implementations, the reflective element may include a mirror or an optical prism.

In at least some implementations, the FOV enhancement unit may include a wide angle lens.

In at least some implementations, the FOV enhancement unit may be configured to redirect the FOV of the at least one sensing unit toward a body part of interest of the user. In at least some implementations, the body part of interest may include at least a hand of the user.

In at least some implementations, the holder may include a pair of goggles configured to seal off a space between the eyewear piece and a face of the user to prevent an ambient light from entering the space.

In at least some implementations, the eyewear piece may further include a motion sensor configured to sense a motion of the eyewear piece and output a motion sensing signal indicative of the sensed motion.

In at least some implementations, the HMD may further include a mobile device having a first primary side and a second primary side opposite the first primary side. The mobile device may include a display unit, at least one sensing unit, and a processing unit. The display unit may be on the first primary side of the mobile device. The at least one sensing unit may be on the second primary side of the mobile device. The at least one sensing unit may be configured to detect a presence of an object. The processing unit may be configured to control operations of the display unit and the at least one sensing unit. The processing unit may be configured to receive data associated with the detecting from the at least one sensing unit, and determine one or more of a position, an orientation and a motion of the object based at least in part on the received data.

In at least some implementations, the mobile device may include a smartphone, a tablet computer, a phablet, or a portable computing device.

In at least some implementations, the at least one sensing unit may include a camera, dual cameras, or a depth camera.

In at least some implementations, the at least one sensing unit may include an ultrasound sensor.

In at least some implementations, the at least one sensing unit may include a camera and an ultrasound sensor.

In at least some implementations, the at least one sensing unit may include a camera. The processing unit may be configured to perform one or more operations comprising increasing a frame rate of the camera, lowering a resolution of the camera, adopting 2×2 or 4×4 pixel binning or partial pixel sub-sampling, or deactivating an auto-focus function of the camera.

In at least some implementations, the mobile device may further include a wireless communication unit configured to at least wirelessly receive a signal from a wearable computing device worn by the user. In at least some implementations, the processing unit may be also configured to determine one or more of the position, the orientation and the motion of the object based on the received data and the received signal.

In at least some implementations, the mobile device further comprises an image signal processor (ISP) configured to provide a first mode and a second mode. The first mode may be optimized for general photography. The second mode may be optimized for continuous tracking, analysis and decoding of information related to tracking of the object.

In at least some implementations, the FOV enhancement unit may include a wide angle lens. The at least one sensor may include a camera. The wide angle lens may be disposed in front of the camera such that an angle of a FOV of the camera through the wide angle lens is at least enough to cover an observation target of interest.

In at least some implementations, the processing unit may be also configured to render a visual image displayable by the display unit in a context of VR.

In at least some implementations, the visual image may correspond to the detected object.

In one aspect, a HMD may include a mobile device and an eyewear piece. The mobile device may have a first primary side and a second primary side opposite the first primary side. The mobile device may include a display unit on the first primary side, at least one sensing unit on the second primary side, and a processing unit. The at least one sensing unit may be configured to detect a presence of an object. The processing unit may be configured to control operations of the display unit and the at least one sensing unit. The processing unit may be also configured to receive data associated with the detecting from the at least one sensing unit. The processing unit may be further configured to determine one or more of a position, an orientation and a motion of the object based at least in part on the received data. The eyewear piece may be wearable on or around the forehead of a user similar to how a pair of goggles are typically worn. The eyewear piece may include a holder and a FOV enhancement unit. The holder may be wearable by a user on a forehead thereof, and configured to hold the mobile device in front of eyes of the user. The FOV enhancement unit may be configured to enlarge or redirect a FOV of the at least one sensing unit.

In at least some implementations, the mobile device may include a smartphone, a tablet computer, a phablet, or a portable computing device.

In at least some implementations, the at least one sensing unit may include a camera.

Alternatively, the at least one sensing unit may include dual cameras.

Alternatively, the at least one sensing unit may include a depth camera.

Alternatively, the at least one sensing unit may include an ultrasound sensor.

Alternatively, the at least one sensing unit may include a camera and an ultrasound sensor.

In at least some implementations, the at least one sensing unit may include a camera. Additionally, the processing unit may be configured to perform one or more operations comprising increasing a frame rate of the camera, lowering a resolution of the camera, adopting 2×2 or 4×4 pixel binning or partial pixel sub-sampling, or deactivating an auto-focus function of the camera.

In at least some implementations, the at least one sensing unit may include a motion sensor configured to sense a motion of the mobile device and output a motion sensing signal indicative of the sensed motion. The processing unit may be configured to receive the motion sensing signal from the motion sensor and compensate for the sensed motion in a VR application.

In at least some implementations, the eyewear piece may also include a motion sensor configured to sense a motion of the eyewear piece and output a motion sensing signal indicative of the sensed motion. The processing unit may be configured to receive the motion sensing signal from the motion sensor and compensate for the sensed motion in a VR application.

In at least some implementations, the mobile device may further include a wireless communication unit configured to at least wirelessly receive a signal from a wearable computing device worn by the user. In at least some implementations, the processing unit may be also configured to determine one or more of the position, the orientation and the motion of the object based on the received data and the received signal.

In at least some implementations, the mobile device further comprises an ISP configured to provide a first mode and a second mode. The first mode may be optimized for general photography. The second mode may be optimized for continuous tracking, analysis and decoding of information related to tracking of the object.

In at least some implementations, the FOV enhancement unit may include a reflective element. In at least some implementations, the reflective element may include a mirror.

In at least some implementations, the FOV enhancement unit may include a wide angle lens. In at least some implementations, the at least one sensor may include a camera, and the wide angle lens may be disposed in front of the camera such that an angle of a FOV of the camera through the wide angle lens is at least enough to cover an observation target of interest.

In at least some implementations, the FOV enhancement unit may be configured to redirect the FOV of the at least one sensing unit toward a body part of interest of the user. In at least some implementations, the body part of interest may include at least a hand of the user.

In at least some implementations, the processing unit may be also configured to render a visual image displayable by the display unit in a context of VR. In at least some implementations, the visual image may correspond to the detected object.

In at least some implementations, the holder may include a pair of goggles configured to seal off a space between the eyewear piece and a face of the user to prevent an ambient light from entering the space.

In yet another aspect, a HMD may include a mobile device and an eyewear piece. The mobile device may have a first primary side and a second primary side opposite the first primary side. The mobile device may include a display unit on the first primary side, at least one sensing unit on the second primary side, and a processing unit. The at least one sensing unit may be configured to detect a presence of an object. The at least one sensing unit may include one or two cameras, a depth camera, an ultrasound sensor, or a combination thereof. The processing unit may be configured to control operations of the display unit and the at least one sensing unit. The processing unit may be also configured to receive data associated with the detecting from the at least one sensing unit. The processing unit may be further configured to determine one or more of a position, an orientation and a motion of the object based at least in part on the received data. The eyewear piece may be wearable on or around the forehead of a user similar to how a pair of goggles are typically worn. The eyewear piece may include a holder and a FOV enhancement unit. The holder may be wearable by a user on a forehead thereof, and configured to hold the mobile device in front of eyes of the user. The FOV enhancement unit may be configured to enlarge or redirect a FOV of the at least one sensing unit by redirecting the FOV of the at least one sensing unit toward a body part of interest of the user. The FOV enhancement unit may include a mirror, a wide angle lens or an optical prism.

In at least some implementations, the mobile device may include a smartphone, a tablet computer, a phablet, or a portable computing device.

In at least some implementations, the at least one sensing unit may include a motion sensor configured to sense a motion of the mobile device and output a motion sensing signal indicative of the sensed motion. The processing unit may be configured to receive the motion sensing signal from the motion sensor and compensate for the sensed motion in a VR application.

In at least some implementations, the eyewear piece may also include a motion sensor configured to sense a motion of the eyewear piece and output a motion sensing signal indicative of the sensed motion. The processing unit may be configured to receive the motion sensing signal from the motion sensor and compensate for the sensed motion in a VR application.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A head-mounted display, comprising:
an eyewear piece comprising:
a holder that is wearable by a user on a forehead thereof, the holder configured to hold a mobile device in front of eyes of the user; and
a field of view (FOV) enhancement unit configured to enlarge or redirect a FOV of one or more sensing units of the mobile device when the mobile device is held by the holder.

2. The head-mounted display of claim 1, wherein the FOV enhancement unit comprises a reflective element.

3. The head-mounted display of claim 2, wherein the reflective element comprises a mirror or an optical prism.

4. The head-mounted display of claim 1, wherein the FOV enhancement unit comprises a wide angle lens.

5. The head-mounted display of claim 1, wherein the FOV enhancement unit is configured to redirect the FOV of the at least one sensing unit toward a body part of interest of the user.

6. The head-mounted display of claim 5, wherein the body part of interest comprises at least a hand of the user.

7. The head-mounted display of claim 1, wherein the holder comprises a pair of goggles configured to seal off a space between the eyewear piece and a face of the user to prevent an ambient light from entering the space.

8. The head-mounted display of claim 1, wherein the eyewear piece further comprises a motion sensor configured to sense a motion of the eyewear piece and output a motion sensing signal indicative of the sensed motion.

9. The head-mounted display of claim 1, further comprising:
a mobile device having a first primary side and a second primary side opposite the first primary side, the mobile device comprising:
a display unit on the first primary side;
at least one sensing unit on the second primary side, the at least one sensing unit configured to detect a presence of an object; and
a processing unit configured to control operations of the display unit and the at least one sensing unit, the processing unit also configured to receive data associated with the detecting from the at least one sensing unit, the processing unit further configured to determine one or more of a position, an orientation and a motion of the object based at least in part on the received data.

10. The head-mounted display of claim 9, wherein the mobile device comprises a smartphone, a tablet computer, a phablet, or a portable computing device.

11. The head-mounted display of claim 9, wherein the at least one sensing unit comprises a camera, dual cameras, or a depth camera.

12. The head-mounted display of claim 9, wherein the at least one sensing unit comprises an ultrasound sensor.

13. The head-mounted display of claim 9, wherein the at least one sensing unit comprises a camera and an ultrasound sensor.

14. The head-mounted display of claim 9, wherein the at least one sensing unit comprises a camera, and wherein the processing unit is configured to perform one or more operations comprising increasing a frame rate of the camera, lowering a resolution of the camera, adopting 2×2 or 4×4 pixel binning or partial pixel sub-sampling, or deactivating an auto-focus function of the camera.

15. The head-mounted display of claim 9, wherein the at least one sensing unit comprises a motion sensor configured to sense a motion of the mobile device and output a motion sensing signal indicative of the sensed motion, and wherein the processing unit is configured to receive the motion sensing signal from the motion sensor and compensate for the sensed motion in a virtual reality (VR) application.

16. The head-mounted display of claim 9, wherein the eyewear piece further comprises a motion sensor configured to sense a motion of the eyewear piece and output a motion sensing signal indicative of the sensed motion, and wherein the processing unit is configured to receive the motion sensing signal from the motion sensor and compensate for the sensed motion in a virtual reality (VR) application.

17. The head-mounted display of claim 9, wherein the mobile device further comprises a wireless communication unit configured to at least wirelessly receive a signal from a wearable computing device worn by the user.

18. The head-mounted display of claim 17, wherein the processing unit is also configured to determine one or more of the position, the orientation and the motion of the object based on the received data and the received signal.

19. The head-mounted display of claim 9, wherein the mobile device further comprises an image signal processor (ISP) configured to provide a first mode and a second mode, the first mode optimized for general photography, the second mode optimized for continuous tracking, analysis and decoding of information related to tracking of the object.

20. The head-mounted display of claim 9, wherein the FOV enhancement unit comprises a wide angle lens, and wherein the at least one sensor comprises a camera, and wherein the wide angle lens is disposed in front of the camera such that an angle of a FOV of the camera through the wide angle lens is at least enough to cover an observation target of interest.

21. The head-mounted display of claim 9, wherein the processing unit is also configured to render a visual image displayable by the display unit in a context of virtual reality (VR).

22. The head-mounted display of claim 21, wherein the visual image corresponds to the detected object.

23. A head-mounted display, comprising:
a mobile device having a first primary side and a second primary side opposite the first primary side, the mobile device comprising:
a display unit on the first primary side;
at least one sensing unit on the second primary side, the at least one sensing unit configured to detect a presence of an object, the at least one sensing unit comprising one or two cameras, a depth camera, an ultrasound sensor, or a combination thereof; and
a processing unit configured to control operations of the display unit and the at least one sensing unit, the processing unit also configured to receive data associated with the detecting from the at least one sensing unit, the processing unit further configured to determine one or more of a position, an orientation and a motion of the object based at least in part on the received data; and
an eyewear piece comprising:
a holder that is wearable by a user on a forehead thereof, the holder configured to hold the mobile device in front of eyes of the user; and
a field of view (FOV) enhancement unit configured to enlarge or redirect a FOV of the at least one sensing unit by redirecting the FOV of the at least one sensing unit toward a body part of interest of the user, the FOV enhancement unit comprising a mirror, a wide angle lens or an optical prism.

24. The head-mounted display of claim 23, wherein the at least one sensing unit comprises a motion sensor configured to sense a motion of the mobile device and output a motion sensing signal indicative of the sensed motion, and wherein the processing unit is configured to receive the motion sensing signal from the motion sensor and compensate for the sensed motion in a virtual reality (VR) application.

25. The head-mounted display of claim 23, wherein the eyewear piece further comprises a motion sensor configured to sense a motion of the eyewear piece and output a motion sensing signal indicative of the sensed motion, and wherein the processing unit is configured to receive the motion sensing signal from the motion sensor and compensate for the sensed motion in a virtual reality (VR) application.
